(19) United States
(12) Patent Application Publication
(10) Pub. No.: US 2012/0143878 A1
(43) Pub. Date: Jun. 7, 2012

(54) ELECTRONIC MAP GENERATION

(76) Inventors: Timothy Brian Fendley, Bathford Hill (GB); Martin Jacobson, Romford (GB)

(21) Appl. No.: 13/289,341

(22) Filed: Nov. 4, 2011

Related U.S. Application Data
(63) Continuation of application No. PCT/GB2010/000904, filed on May 4, 2010.

(30) Foreign Application Priority Data
May 5, 2009 (GB) 0907719.9

(51) Int. Cl. G06F 17/30

(52) U.S. Cl. 707/748; 707/756; 707/E17.009

(57) ABSTRACT

A method of generating a customised map comprises: taking first, map data for generating a map; taking second, asset data, the asset data comprising a plurality of asset locations on the map and the locations having a label associated therewith; and applying the asset data to the map data to produce an initial labelled map. One or more predetermined rules is applied to the labels to determine whether any group of labels on the initial labelled map is in conflict. For those groups of labels determined to be in conflict, an algorithm is applied to move one or more of the labels in the pair or group to remove or reduce the conflict.

### CROSS-REFERENCED APPLICATIONS

This application is a continuation application of PCT International No. PCT/GB2010/000904, filed on May 4, 2010, and claims priority to Great Britain Patent Application No. 0907719.9, filed on May 5, 2009, both of which are incorporated herein in their entirety by reference thereto.

### BACKGROUND

1. Field of the Disclosure

This disclosure relates to the automatic production of maps and in particular to the real-time production of customised maps from one or more comprehensive source of map data.

2. Discussion of the Background Art

Recently there has been an increased need to produce customised maps both for mobile device applications and for large scale implementation of street level pedestrian mapping projects. In both situations commonly a map is required which is not simply a subsection of a larger map but which is customised for a particular purpose, location or user. In the field of cartography such adaptation of map data is known as generalisation. Generalisation refers to the design decisions involved in creating a map which is fit for purpose. This may entail a reduction in information density in line with a reduction in scale, or the exclusion of footpaths for a road atlas for instance. Generalisation allows for variability in the selection and visual representation of geographic data according to purpose, scale and/or medium on which the map is to be displayed.

Various methods and applications of automated generalisation have been described, and are available in commercial geographic information system (GIS) packages. These are generally tasked with producing small-scale or highly abstracted maps from large-scale geographic data. They are generally limited to a predefined set of visual designs and content selections and are not capable of producing maps on demand to individual designs or specifications.

One of the main problems that arises in producing a map is that of optimal label positioning. Significant features on the map (which may depend on the type or purpose of the map) must be labelled in such a way that the labels are clear, legible, proximate to the feature, and such that a given label neither obscures, nor is obscured by other labels and features. Mathematically the problem of label positioning is a pure combinatorial problem—i.e. there is no analytical solution possible. It can only be tackled by examining individual combinations of positions, the problem-space, and determining whether or not the combination is a solution (by some criterion) to the problem. There may be more than one solution possible, in which case some solutions may be preferable to others.

The problem is described mathematically as of the class NP-hard: if every label can take up one of X positions, and there are N labels, the number of different ways of positioning the labels is X^{N}. With N typically in the low hundreds, even a small value of X gives an extremely large number of combinations. Thus whilst theoretically a solution could be sought by searching exhaustively through all possible solutions, the sheer number that would be involved makes it impossible in practice for the problem to be solved by exhaustive search.

Another possible approach is to select potential solutions at random (the so-called “Monte Carlo” approach). This might be a good approach if it is known that there are a number of solutions, any of which is acceptable, but otherwise, it is no better than an exhaustive search.

Another method is a form of local optimisation, known as the Simplex method. Simplex methods consist of taking a given combination of positions, and looking for a single change in position of any one label that produces a better value than the starting value. The process is repeated until no improvement can be found. If this is a solution, then the problem is solved but, unfortunately, there is no guarantee that a solution will be found. The Simplex method will normally converge on a local minimum of the value of a measure of variance from optimum, but has no way of getting from a local to a global minimum position.

An improvement to the Simplex method would be to use the Monte Carlo method to choose initial positions, which Simplex could explore to find the local minimum. If this were not an acceptable solution, then another random combination could provide a new initial position. However this has the disadvantage that if a new random starting position is chosen the previous position is ‘thrown away’ completely.

A more sophisticated approach is proposed in WO 2006/027773. This uses a method called “simulated annealing”. This is analogous to the metallurgical process of annealing which allows a piece of metal to find a low energy configuration by first heating it up, and then letting it cool slowly. When the metal is hot, the atoms can move about relatively freely, and as it cools, the atoms have less energy and tend to settle into low energy configurations. The atoms ‘prefer’ to be in low energy positions but, when hot, may jump into higher energy configurations before settling into a lower energy position again.

Carrying this idea across to the problem of optimum label positioning, the standard Simplex method is modified by temporarily accepting a worse position. At any given point the current position in the problem space, that is the candidate set of positions for all the labels, can be ascribed an associated value representing the extent to which it is removed from being an optimum solution, which can be thought of as the analogue of the ‘energy’ of that potential solution or ‘state’. Changing the position of one label changes the state from state i to i+1, and the energy changes from Eᵢ to Eᵢ₊₁. The change in energy Eᵢ₊₁−Eᵢ is written as εᵢ. The Boltzmann Distribution from thermodynamic theory describes the probability that a system is in a given state based on the energy of that state and the temperature of the system. Using this, the probability that the system energy would increase by εᵢ can be written as:

Pᵢ=e^{-ε}^{ᵢ}^{/kT}

where T is the temperature, and k is a constant (in thermodynamics, this is Boltzmann's constant).

Clearly, when εᵢ is negative (that is, the new state is a lower energy state), the probability exceeds 1: that is, the new state will be accepted. However, if εᵢ is positive (corresponds to a higher-energy state), the probability of this can be calculated. By comparing this probability to a uniform random deviate (as produced by a standard random number generator), the new state can be accepted or not according to the calculated probability. The probability that the change will be accepted goes down as the energy change increases, but goes up as the temperature increases.

So, in simulated annealing, from a given starting position and a starting temperature, new candidate states are selected by choosing a new label position for a particular label chosen arbitrarily. If the change in energy is negative, the new position is accepted; if the change is positive, the probability is calculated, and if it exceeds a randomly generated number, the change is accepted. This process continues, while gradually reducing the ‘temperature’ until either the solution is found, or the ‘temperature’ reaches ‘absolute zero’ and no more improvements are possible. At high temperatures, almost any change will be accepted, and so the method resembles the Monte Carlo method, while at very low temperatures only lower-energy transitions will be accepted, and so the method then resembles the Simplex method. Simulated annealing has to be tuned to find good values for the constant k, initial temperature T, and rate of reduction of temperature, but it offers the possibility of finding solutions without requiring a prohibitive amount of time or computing power.

However the Applicant has realised that the simulated annealing approach set out above has some drawbacks and that a different approach might be beneficial in some circumstances.

### SUMMARY OF THE DISCLOSURE

When viewed from a first aspect the disclosure provides a method of generating a customised map comprising: taking first, map data for generating a map; taking second, asset data, said asset data comprising a plurality of asset locations on said map and said locations having a label associated therewith; applying said asset data to said map data to produce an initial labelled map; applying one or more predetermined rules to said labels to determine whether any group of labels on the initial labelled map is in conflict; for those groups of labels determined to be in conflict, applying an algorithm to move one or more of the labels in the pair or group to remove or reduce the conflict.

Thus it will be seen by those skilled in the art that in accordance with the present disclosure, a determination is made as to which labels are in conflict with one another before the algorithm for reducing or resolving label conflicts is applied only to those labels in conflict. This contrasts sharply with the known simulated annealing method. It stems from a recognition that in ‘classic’ simulated annealing the whole initial map is ‘heated’ but that this is inefficient. When the initial version of a map is generated in the known technique, every label is initially placed in its preferred—that is, lowest energy—position. However candidate labels for shifting are chosen arbitrarily. This means in practice that labels already optimally positioned, and not in conflict can be selected. Given that when the temperature is high all changes are likely to be accepted, this results in many labels being repositioned uselessly, although there will be an eventual improvement overall.

In accordance with the disclosure however, only labels that are in conflict are selected as candidates for repositioning. This tends to leave unaffected labels in their optimal position, and means that the algorithm concentrates on those labels that are in conflict. A method embodying the disclosure has proved to be as much as an order of magnitude faster than simulated annealing in tests on typical maps.

The labels could be textual labels, symbols, pictures or indeed any distinctive discrete indicia. The groups could consist of two or more labels.

Any suitable algorithm could be applied to the labels in conflict. Given that the problem space(s) in some embodiments may be much smaller, in aggregate, than the whole map, it may be feasible to revert to simpler ‘brute force’ algorithms for resolving the conflicts such as exhaustive searching. In preferred embodiments of the disclosure however, simulated annealing is applied to the groups of labels determined to be in conflict. Conceptually this is analogous to applying ‘heat’ only to areas of the map containing conflicts.

Where a plurality of conflicts is identified these could be resolved sequentially. Preferably however at least some are resolved in parallel with one another. This further reduces processing time. The Applicant has recognised that in many practical embodiments, there are relatively few conflicts and that the locations of the conflicts are relatively widely spaced such that the labels involved can be shifted from their initial positions without impacting on the labels being shifted in other embodiments. In one set of embodiments a threshold separation criterion is applied to ensure that there is sufficient separation between respective groups of conflicted labels to permit reliable parallel processing to resolve conflicts. Put simply, two conflict groups are too close to be processed independently if any of the potential label positions from one begin to overlap with any potential label positions from the other conflict. Pragmatically the separation criterion might specify a greater minimum separation. The potential label positions in each area of conflict will in general depend on the range of movement of individual label positions permitted by the optimisation algorithm.

A group of labels in conflict need not be limited only to those labels which actually overlap each other. It might include pairs or sub-groups of labels which are within a specified distance of one another—e.g. those which are not far apart enough to be processed independently.

In some embodiments of the disclosure the algorithm can be set to terminate as soon as there are no longer any labels in the group in conflict. However the Applicant has recognised that this could leave some of the labels that were previously in conflict in positions that, though they are no longer in conflict, are not optimal. For example they might be further from the asset location on the map than is strictly necessary to avoid the conflict. In accordance with a set of embodiments therefore, the method includes the step of ranking the labels in the conflict group by their variance from an optimal position ('energy') and selecting labels for re-positioning based on said ranking. Labels at the beginning of the list with higher energies, therefore—are more likely to be selected for repositioning than labels at the end of the list.

This modification to the algorithm can provide near-perfect label positioning, albeit at the cost of a longer processing time. However, even though the processing time may be longer on average in these embodiments, it will still typically provide much improved performance in comparison with a ‘classic’ simulated annealing algorithm.

The algorithm could be terminated when a threshold energy is reached, after a certain number of steps has been carried out or a combination thereof.

The algorithm preferably comprises: for any label selected for repositioning, selecting one of a plurality of predetermined positions for the label relative to the associated asset. Preferably each of said predetermined positions is assigned an energy value, e.g. dependent on its displacement from a predetermined optimum position, although other criteria could be used as well or instead. The selection of said predetermined position could be made randomly, but preferably it is made with a probability dependent on the energy value. This recognises that a high energy value for one label may be acceptable to reduce the overall energy value of the map (by avoiding a conflict). In one example the probability of a predetermined position is inversely exponentially related to its energy value.

In accordance with the disclosure certain types of map features (known in the art as “assets”) could be included or omitted depending upon the extent of label conflicts. Where simulated annealing is used assets could be included or omitted based on the initial energy, the final energy or a combination of the two. For example WO 2006/027773 teaches omitting assets as necessary to reduce the level of conflicts. This approach can also be used in embodiments of the disclosure.

In preferred embodiments of the disclosure however, the assets to be included are determined before labels are positioned and, if necessary, label conflicts are resolved. This is advantageous in allowing more fully customisable maps to be produced, whereby asset types can be specified as well as the centre, scale and size of the map for example. It also minimises the complexity of the label positioning optimisation algorithm.

When viewed from a further aspect the disclosure provides a method of generating a customised map comprising: taking first, map data for generating a map; taking second, asset data as a predetermined data set, said asset data comprising a plurality of asset locations on said map and said locations having a label associated therewith; applying said asset data set to said map data to produce an initial labelled map; applying an automatic algorithm to move one or more of the labels to remove or reduce the conflict such that all the labels on the initial labelled map are retained.

In some embodiments, a maximum number of assets for a map is specified. Assets may then be included or not based on rankings which could reflect the purpose of the map.

The disclosure extends to an apparatus adapted to carry out the methods specified in accordance with the disclosure and to a computer software product adapted, when run on suitable data processing means, to carry out the methods of the disclosure.

In some preferred embodiments of the disclosure the method comprises the step of storing a computer image or map file in a computer memory or other volatile or non-volatile storage medium. In some preferred embodiments of the disclosure the method comprises the step of printing a map. In some preferred embodiments of the disclosure the method comprises the step of transferring data for displaying or printing a map across a wired or wireless network.

### BRIEF DESCRIPTION OF THE DRAWINGS

A preferred embodiment of the disclosure will now be described, by way of example only, with reference to the accompanying drawings in which:

FIG. 1 is a schematic diagram giving an overview of a system embodying the present disclosure;

FIG. 2 shows an example extract of an intermediate map in which asset and topographic data have been combined to associate parts of the map with assets;

FIGS. 3a and 3b show how a spatial database is cut down to produce a map with desired customisation criteria;

FIGS. 4a to 4c show respective steps in a label position optimisation algorithm; and

FIG. 5 shows diagrammatically how label position optimisation can be carried out using parallel processing.

### DETAILED DESCRIPTION OF THE PREFERRED EMBODIMENT

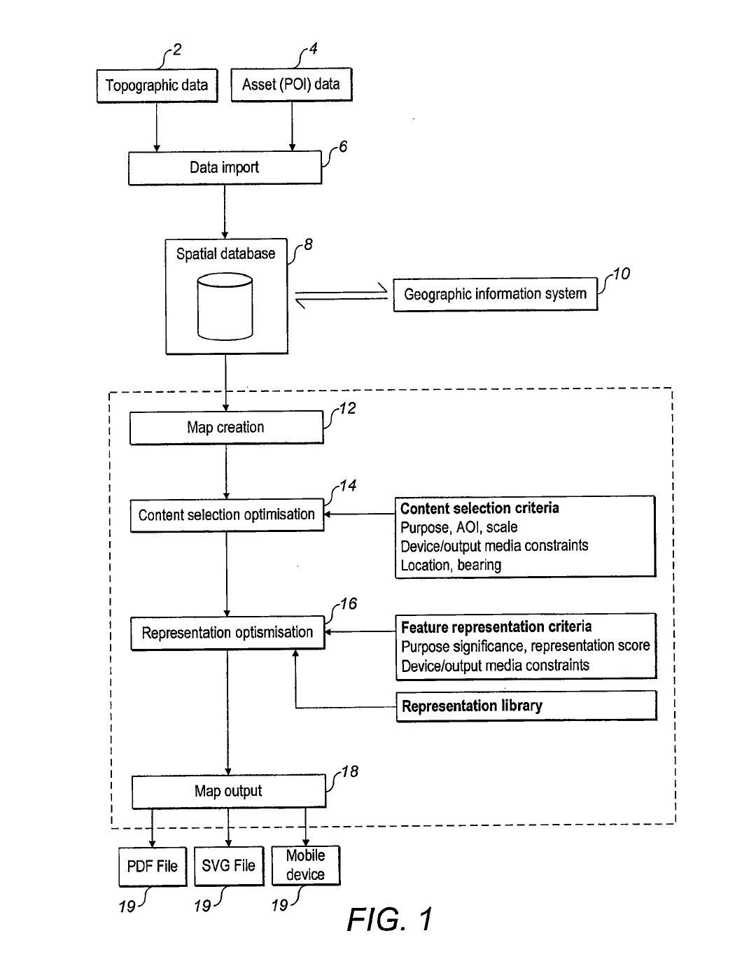

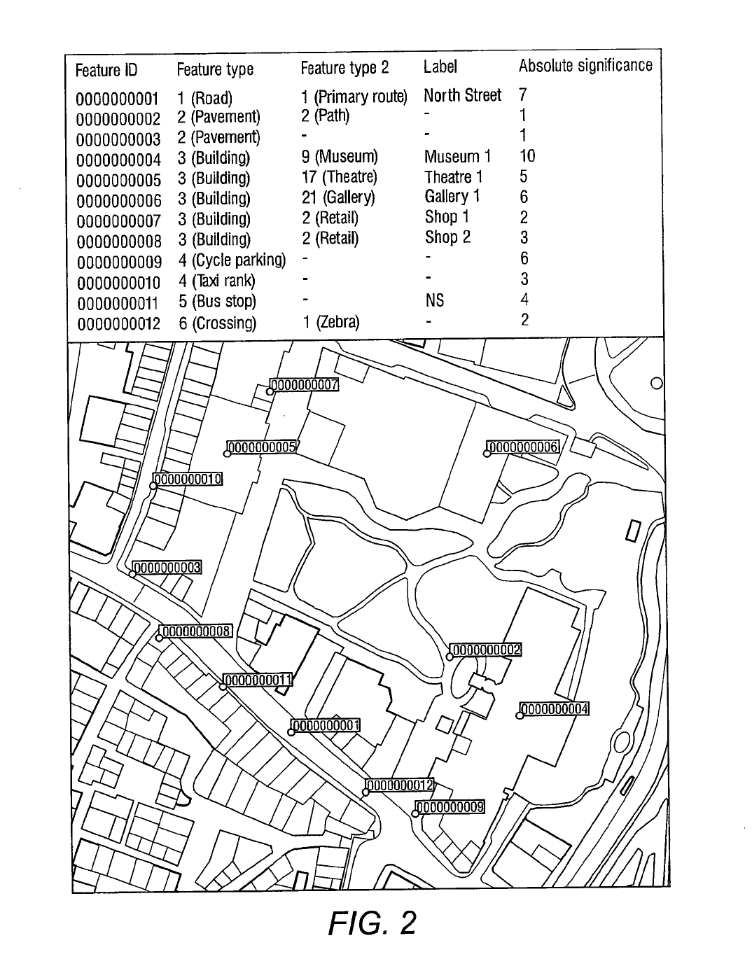

FIG. 1 shows a broad systems diagram of a system for carrying out a method embodying the disclosure. At the top of the diagram, topographic data 2 and asset or point of interest data 4 are imported via a data import module 6 into a spatial database 8. The spatial database 8 is managed by a geographic information system 10 in a manner which is known per se.

The spatial database 8 is used to create a map at step 12 which then undergoes content selection optimisation at step 14 where the content of the map is selected on the basis of the purpose of the map, the area of interest, by the map, the scale, the location, the bearing of the map and any constraints placed by the intended form of output (e.g. whether it is for a printed map, a map to be displayed on a mobile device etc.). For example, if the purpose of the map is for use by shoppers, the area of interest might correspond approximately to a ten minute walking distance from a known location and it might be predetermined that the map is to be printed on an A3 sheet in full colour at an appropriate scale. However, the purpose will also dictate which features it is more important to show.

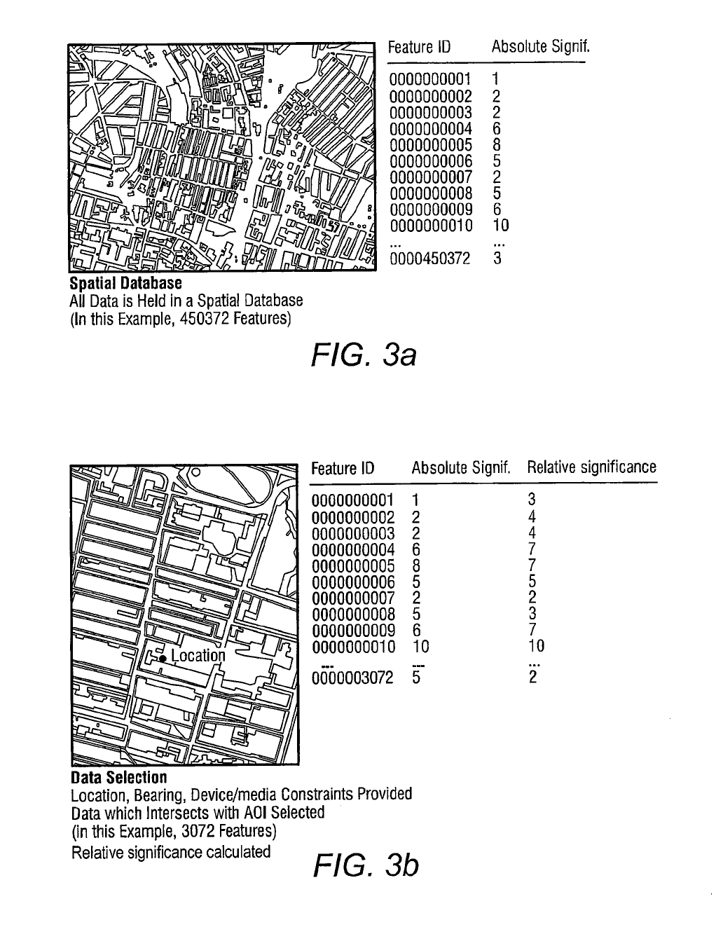

The initial spatial database 8 contains a list of all the available assets/points of interests which can be included or excluded from maps generated from it as required. All of the assets are assigned an “absolute significance” score which can be based, for example, on a subjectively predetermined assessment of a feature's significance in the context of the entire data set. The features are also divided into various categories to assist with the production of purpose-driven maps. FIG. 3a illustrates schematically part of the contents of the spatial database which comprises a pictorial map and a list of features, each with a unique feature ID (in this example there are 450372 features).

Each feature is assigned an absolute significance as mentioned above. From this, a customised map can be created based on a desired location, bearing, purpose and area of interest. The features in the spatial database which are in the area of interest for the target map are then imported into a short list. This is shown diagrammatically by the smaller area map and corresponding table in FIG. 3b. It will be seen that this initial customised map has only 3072 features.

Each is then given a relative or “purpose” significance using predetermined rules determined by the purpose of the map. In the example above of a shopping map, clearly retail outlets would be given a higher significance than they would for a map of points of architectural or historic interest. The relative significance score is also based on the range and occurrences of absolute significance values in the area of interest. Network linkages and constraints between concepts are used extensively to determine purpose significance; these can emerge from the data in question rather than being predefined. For example, a ‘figure of merit’ can be assigned to each potential item, which is determined by taking an ‘inherent merit’ score, to which is added an ‘implied relevance’ score, the sum being weighted by a class relevance score for the class of item. Hence, a map oriented towards the visitor may prioritize museums and art galleries. However, a linkage between either classes or between individual items may show that museums imply a need for cafes, and cafes imply a need for public toilets. Hence, an expressed need for museums can lead to public toilets appearing on the map.

For reasons of legibility the customised map specification may specify a maximum number of features to be displayed. The list of features that are initially generated from applying the area-of-interest criterion to the spatial database may then be reduced further if necessary to meet this criterion. This is done by ranking the features by the purpose significance score. It will be appreciated that fixing the maximum number of features contrasts with features being included or excluded at a later stage depending on label conflicts.

Returning to FIG. 1, the next step 16 is the application of representations to each of the assets which it has been decided to include. Appropriate feature representations are taken from libraries of representation elements (symbols, colours, typographic labels) which are assigned certain values based on subjective assessment (e.g. visual prominence) and objective qualities such as the display size. Together these values form a “representation score” value. A different representation is assigned to each feature category or feature type (including the topographic data) according to their purpose significance values. This means that representations with greater representation scores are assigned to features with greater purpose significance values. The representations which are applied to the assets may be purely diagrammatic, but will often be accompanied by a text label.

The addition of symbols and text labels to the map (these being referred hereinafter collectively as “labels”) can cause problems when the map is reproduced since they need to be of a certain size to be legible but in crowded regions of a map, labels might overlap one another, which is not acceptable. Furthermore, the optimum position of the label may be at the very edge of an area of interest such that it is partly cut off by the edge of the map.

An initial map is produced in which labels are placed in their optimum, or zero-energy, positions. In this embodiment labels comprise a translucent box containing identifying text. However other possibilities such as symbols, pictures, numbers or codes could be employed. For each asset/feature type (building, station, monument etc.) an optimum position for a corresponding label is defined. In this embodiment, the optimum position is with the centre of the label over the centroid of the building, but another definition could be used. As well as an optimum position, for each category of feature—e.g. retail or theatre—a series of further, sub-optimum positions is defined, each with an associated energy value reflecting its undesirability relative to the optimum position. The energy value assigned to a given position could be dependent on the displacement, e.g. proportional to the square of the displacement of the label from its optimum position, although other factors could be taken into account. In one example the optimum position has the label centred on the centroid of the building with the text centre-justified within the box. The secondary position might be to have the label with one corner adjacent a corner on the right-hand side of the building with the text left-justified within the box. The energy level associated with this could be predetermined or calculated when the algorithm is run if it is dependent on the size of the building (as this will determine the displacement of the label from its optimum position).

The rules for determining where the label is placed if not in the optimum position could be defined relative to the building (as in the example given above) or relative to the optimum position (e.g. a displacement and direction relative to the optimum position) or a combination of the two.

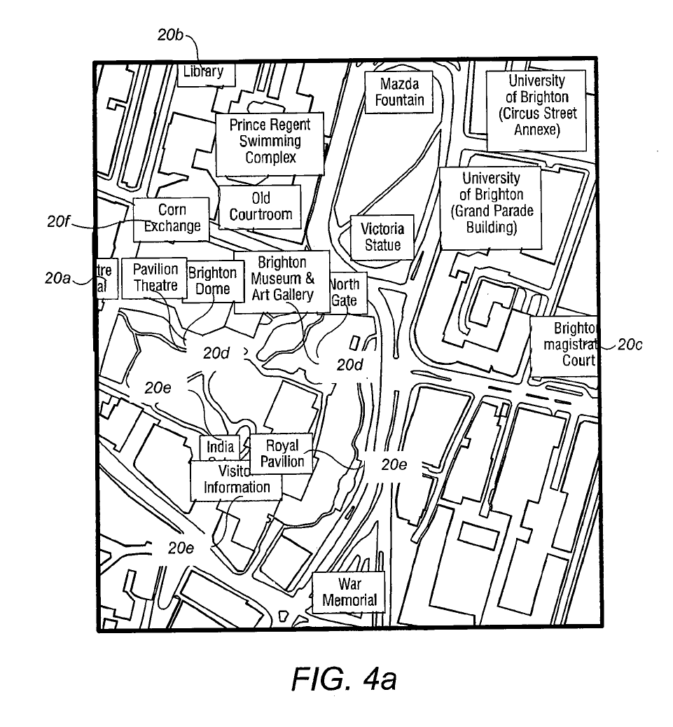

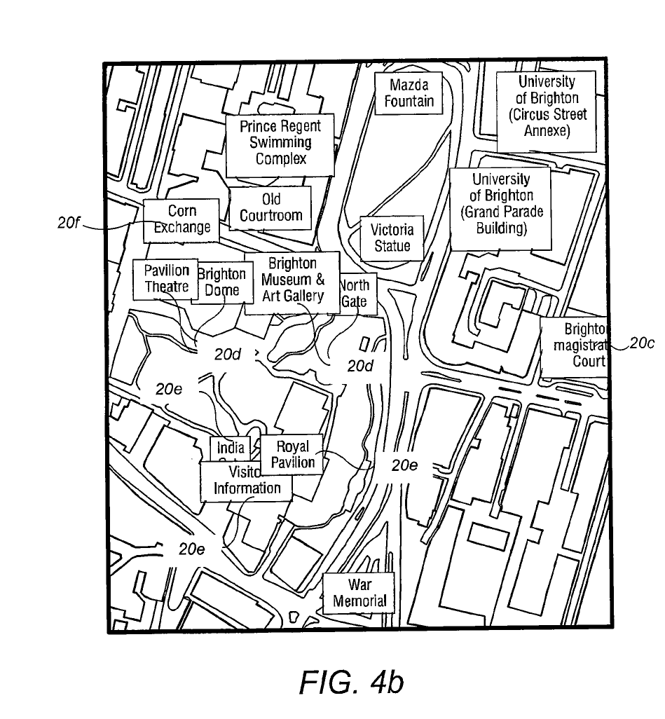

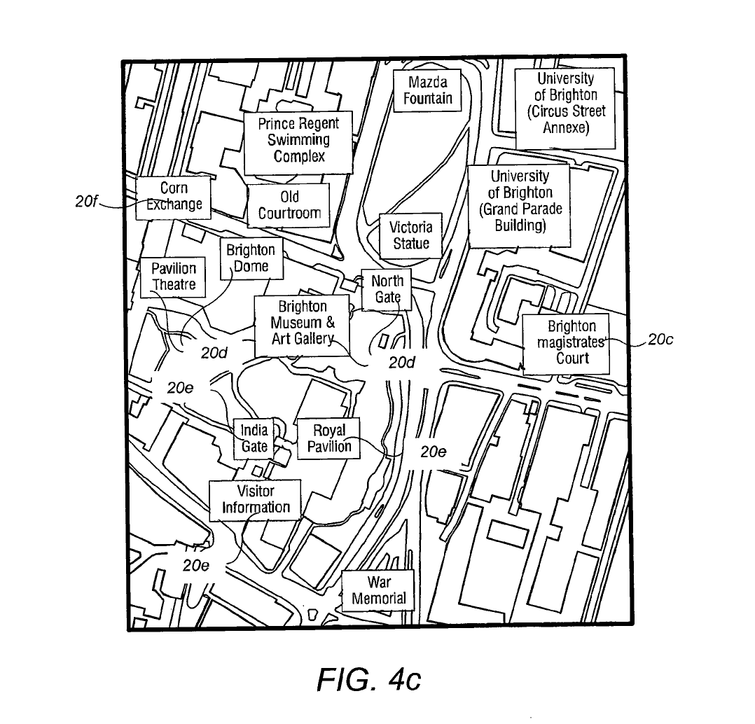

An example of an initial map is shown in FIG. 4a, with all labels placed provisionally in their optimum position relative to the asset they describe. In this map, placing the labels in an optimum position has led to three of the labels 20a, 20b, 20c being partly cut off at the edge of the map. Two sets of labels 20d, 20e partly overlap one another. The remaining labels are legible in their original positions.

In a first step shown in FIG. 4b, two of the outlying labels 20a, 20b whose centres are outside the area-of-interest of the map, have been removed to avoid confusion. A third outlying label 20c is retained since its centre is within the area of interest. However since the label is partly cut-off the label is given a high energy value to reflect this. A high energy is given to each of the labels in the overlapping sets 20d, 20e. The additional energy given is greater than any of the energies attributed to the predefined positions for any label which ensures that the conflicts are resolved.

An iterative algorithm is then run to resolve the labels 20d, 20e in conflict. The algorithm is based on the process of simulated annealing. At each step, one of the conflicted labels is selected. This could be selected at random or on the basis of its energy value as explained below. For the label that is selected, one of its alternative predefined positions is chosen. Again the choice of which among the set of predefined positions will be chosen could be made randomly but is preferably made with a probability dependent on the energy value of the position, e.g. the probability may have a negative exponential dependency on energy value.

Once a new candidate label position has been selected, the resultant aggregate energy of all the labels under consideration is calculated. This calculation of course takes into account the inherent energy value associated with the new label position, but also the change in energy resulting from any change in conflicts—i.e. the reduction resulting from a conflict resolved by the new position or the increase resulting from a new conflict introduced by the new position.

If the overall energy of the new state is lower than it was previously, the state is accepted. If the overall energy is higher, the state may still be accepted, but with a probability calculated using a Boltzmann-type distribution. At each iterative step the parameter analogous to temperature used for the Boltzmann-type distribution is reduced according to an exponential decay. At the beginning of the process, the ‘temperature’ is relatively high, a new configuration will therefore often be adopted as a new candidate position even if the energy of that position is higher than the initial candidate position. However, as the ‘temperature’ is reduced, the energy of states that will be adopted as new candidate positions is gradually reduced. This allows the conflicts to be resolved in a near-optimum manner by avoiding the situation whereby the iteration terminates at a local minimum of the energy value, rather than a global minimum.

Once a conflict between two labels has been resolved they could be removed for the list of labels for random selection to be moved. In a variant however, the labels in the conflict groups are ranked according to their energy (variance from optimal position) and the labels selected for being moved with a probability proportional to their energy. Thus even non-conflicted labels could be moved in a bid to lower their energy. However this is only applied in the conflict groups, not across the map as a whole. The conflict groups are not only those labels in conflict when the initial map is generated, but also those close enough to conflicted labels that a new conflict might arise during the iteration.

The resolved map is shown in FIG. 4c. From here it can be seen that several of the originally conflicted labels 20d, 20e has been moved to avoid the conflict. It can also be seen that one of the labels 20f has been moved since although it was not originally in a conflict, a conflict arose during the algorithm which is resolved with lower energy by moving that label 20f.

However it should be appreciated that the iterative process described above is applied only to the labels 20d, 20e, which are or become in conflict and so does not therefore waste computing resources on processing the other labels, nor does it risk those labels being moved from their original, optimal positions.

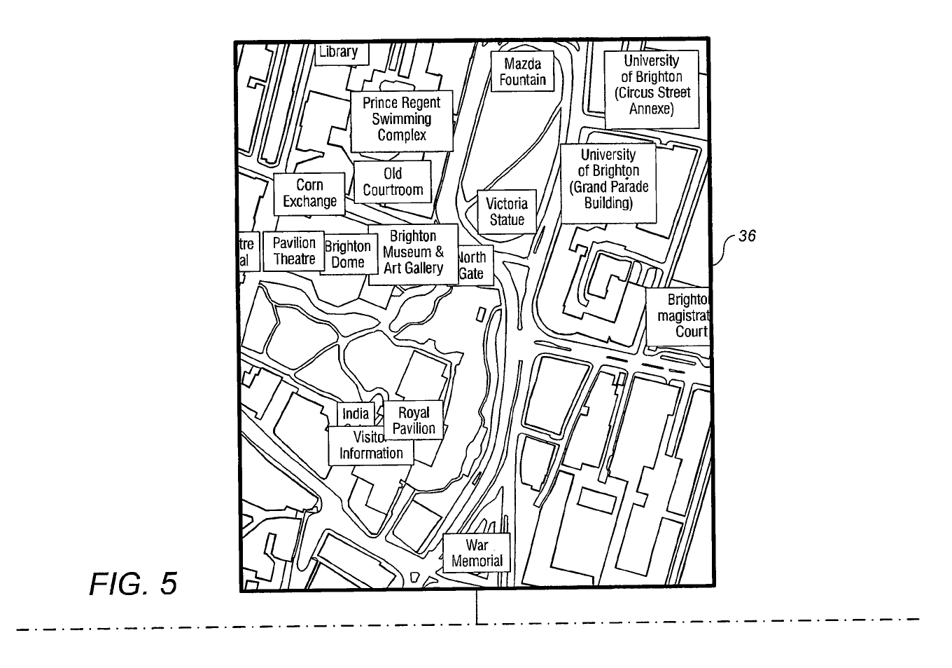

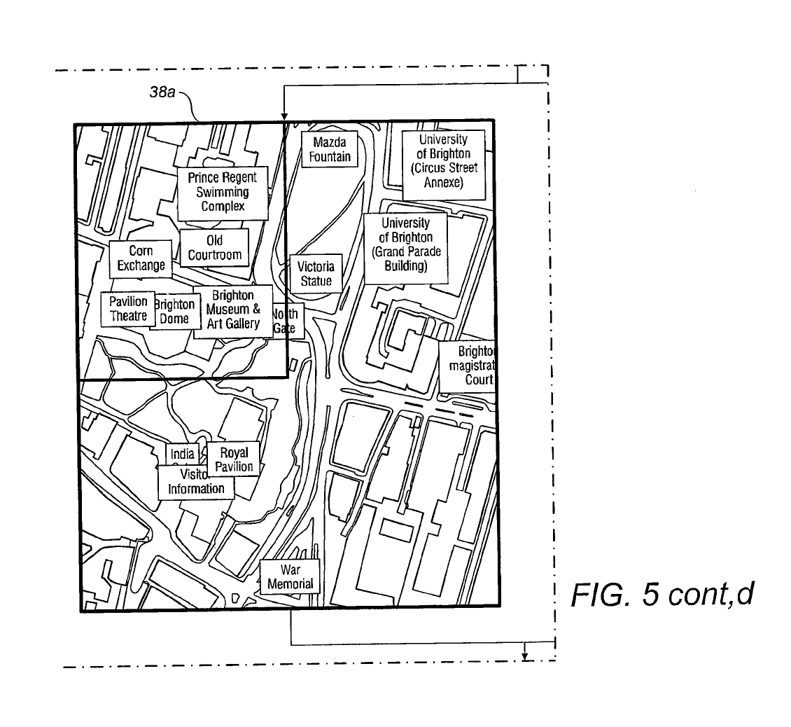

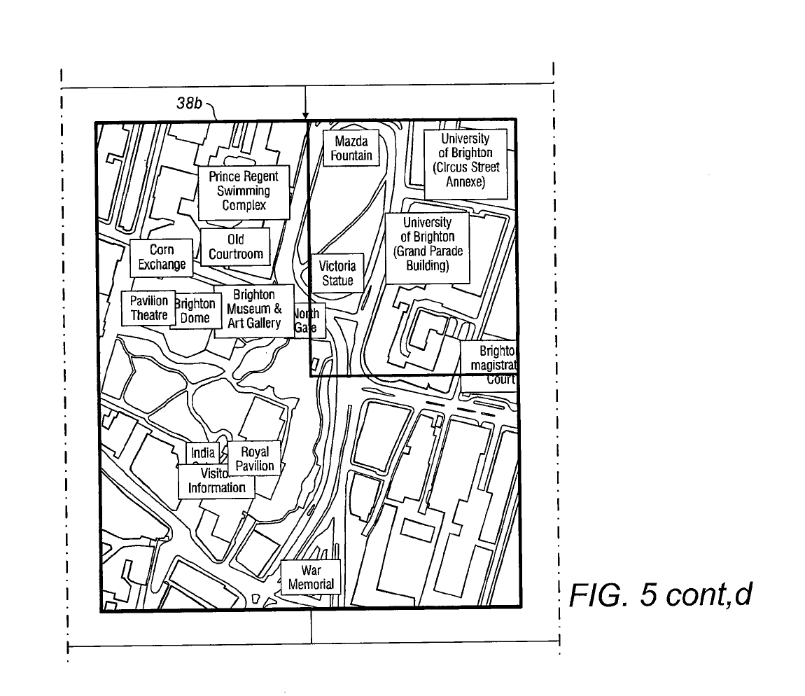

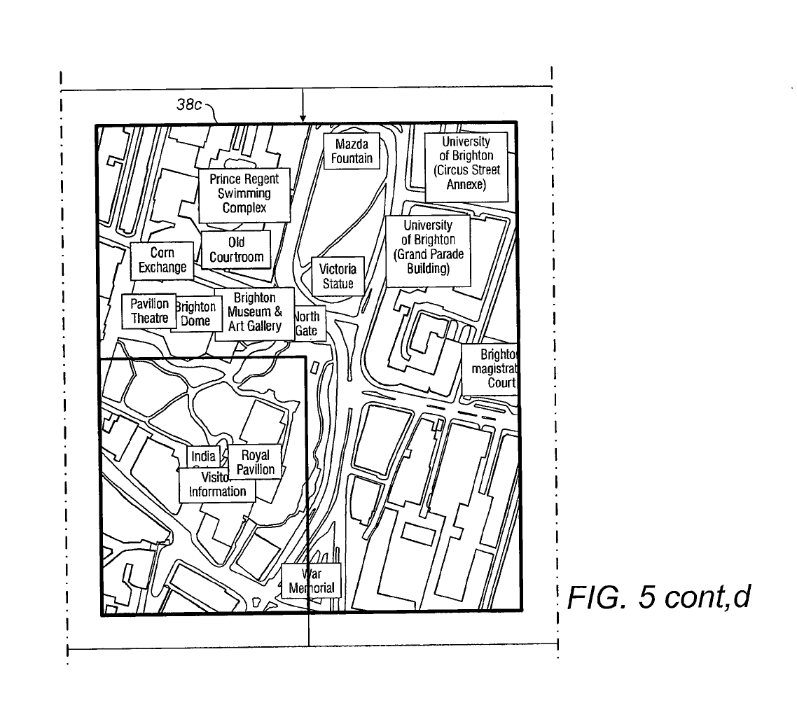

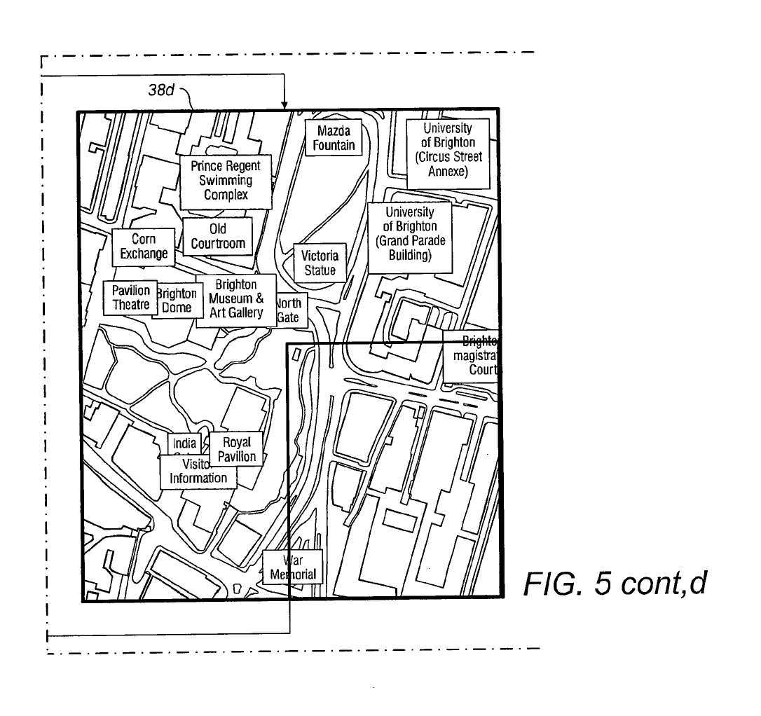

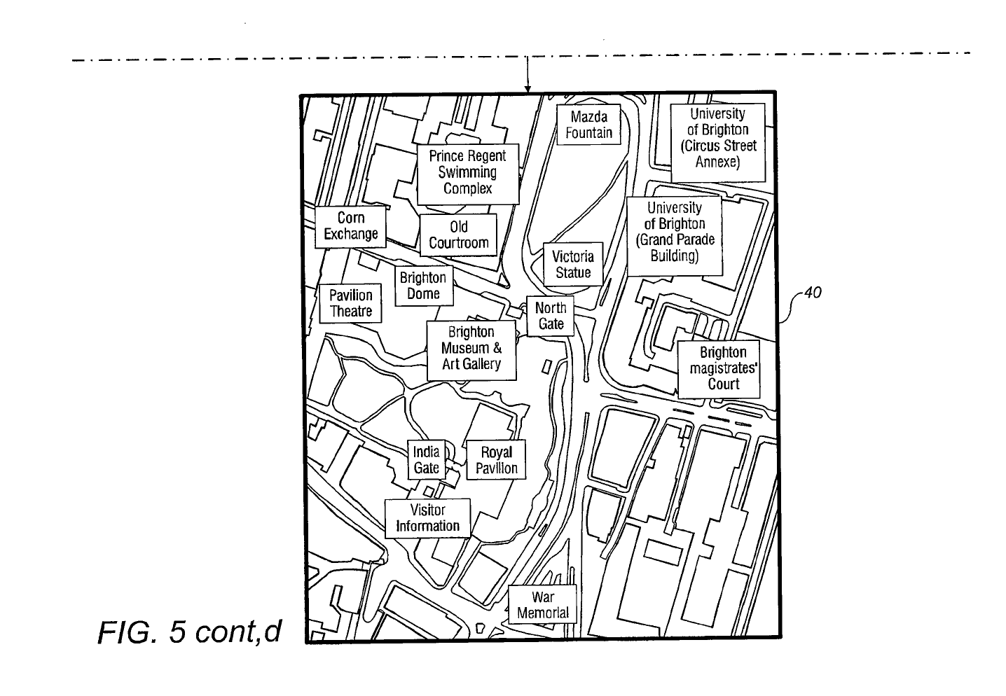

A further preferred feature of some embodiments of the disclosure is illustrated in FIG. 5. This shows schematically an initial map 36 which has two discrete areas in which there are conflicts between labels. These are highlighted in the individual quadrants shown in maps 38a and 38c. The optimised simulated annealing algorithm set out above is applied independently and simultaneously to each of these discrete areas of conflict so that processing can be done in parallel, thereby saving processing time. This is possible because the algorithm is only applied to the areas of conflict rather than to the whole map and further because the areas of conflict are sufficiently separated from one another. For example, the separation of the areas of conflict is greater than the amount by which the labels would be moved during the algorithm.

By contrast the other two quadrants highlighted on maps 38b and 38d do not contain any conflict groups and so do not need to have the algorithm applied. The ‘edge cut-off’ part of the algorithm may be run in the quadrant highlighted in map 38d as this contains the centre of the cut-off label. Of course it is not essential to divide into quadrants—other shapes or sizes may be chosen. Foe example if a conflict group bridges the boundary between two quadrants they could be processed together, or another area chosen around the conflict group.

Finally, the optimised sections of the map 38a to 38d are once again brought together to provide a complete optimised map 40. Any residual conflicts between labels can then be resolved at that stage.

Returning to the main overview, the finalised map is then output in an appropriate format 19 such as a PDF file, an SVG (scalable vector graphics) file or proprietary format e.g. for a mobile device.

It will be appreciated by those skilled in the art that methods in accordance with the disclosure can provide a real-time implementation of automated generalisation for on-demand mapping. It can also provide map situation-specific generalisation, in which the situation and specific user purpose of the outputted map (e.g. a map on street furniture designed for pedestrian wayfinding) drives the cartographic content generalisation and visual representation, according to a design which enables optimum usability for a wide range of situations (in terms of both location and user need). Rather than being limited by a predefined set of visual designs and content selections, a unique map design is created for each particular situation (unless specified otherwise) based on emergent content selection criteria and a library of representations.

1. A method of generating a customised map comprising: taking first, map data for generating a map; taking second, asset data, said asset data comprising a plurality of asset locations on said map and said locations having a label associated therewith; applying said asset data to said map data to produce an initial labelled map; applying one or more predetermined rules to said labels to determine whether any group of labels on the initial labelled map is in conflict; for those groups of labels determined to be in conflict, applying an algorithm to move one or more of the labels in the pair or group to remove or reduce the conflict.

2. A method as claimed in claim 1 comprising applying simulated annealing to the groups of labels determined to be in conflict.

3. A method as claimed in claim 1 comprising resolving a plurality of conflicts in parallel with one another.

4. A method as claimed in claim 4 comprising applying a threshold separation criterion to ensure that there is sufficient separation between respective groups of conflicted labels to be processed in parallel.

5. A method as claimed in claim 1 comprising ranking the labels in the conflict group by their variance from an optimal position and selecting labels for re-positioning based on said ranking.

6. A method as claimed in claim 1 comprising: for any label selected for repositioning, selecting one of a plurality of predetermined positions for the label relative to the associated asset.

7. A method as claimed in claim 6 comprising assigning an energy value to each of said predetermined positions

8. A method as claimed in claim 7 comprising making said selection of said predetermined position with a probability dependent on the energy value.

9. A method as claimed in claim 1 comprising determining the assets to be included before said labels are positioned.

10. A method of generating a customised map comprising: taking first, map data for generating a map; taking second, asset data as a predetermined data set, said asset data comprising a plurality of asset locations on said map and said locations having a label associated therewith; applying said asset data set to said map data to produce an initial labelled map; applying an automatic algorithm to move one or more of the labels to remove or reduce the conflict such that all the labels on the initial labelled map are retained.

11. A method as claimed in claim 10 comprising specifying a maximum number of assets for a map.

12. A method as claimed in claim 10 comprising the step of storing a computer image or map file in a computer memory or other volatile or non-volatile storage medium.

13. A method as claimed in claim 10 comprising the step of printing a map.

14. A method as claimed in claim 10 comprising the step of transferring data for displaying or printing a map across a wired or wireless network.

15. Apparatus adapted to carry out the method claimed in claim 1.

16. A computer software product adapted, when run on suitable data processing means, to carry out the method claimed in claim 1.

17. Apparatus adapted to carry out the method claimed in claim 10.

18. A computer software product adapted, when run on suitable data processing means, to carry out the method claimed in claim 10.
